(19) United States
(12) Patent Application Publication
(10) Pub. No.: US 2015/0287093 A1
(43) Pub. Date: Oct. 8, 2015

(54) SOCIAL MEDIA PROFILE MONETIZATION USING VIEWER ENGAGEMENT TOOLS

(71) Applicant: THE INFLUENTIAL NETWORK, INC., Los Angeles, CA (US)

(72) Inventor: Daniel Steele, Las Vegas, NV (US)

(21) Appl. No.: 14/680,798

(22) Filed: Apr. 7, 2015

Related U.S. Application Data
(60) Provisional application No. 61/976,457, filed on Apr. 7, 2014.

(51) Int. Cl. G06Q 30/02; G06Q 50/00

(52) U.S. Cl. CPC G06Q 30/0269; G06Q 50/01; G06Q 30/0249; G06Q 30/0277

(57) ABSTRACT

A computer-based system for monetizing social media profiles on social media platforms including providing a link or URL for a user publish to a social media profile on a social media platform, where the link or URL is controlled by the system, providing at least one article for the user to publish to the social media platform instructing viewers to select or follow the link or URL, and directing or redirecting a viewer who selects or follows the link or URL to a webpage containing advertising.

### CROSS REFERENCE TO RELATED APPLICATIONS

The present application claims priority to U.S. Provisional Application No. 61/976,457 filed Apr. 7, 2014, which is hereby incorporated by reference in its entirety.

FIELD

The field of the invention relates to systems and methods for monetizing social media profiles on social media platforms.

### BACKGROUND

Online advertising or Internet advertising is the use of the Internet to market products or services to consumers. Many forms of online advertising exist including web banner advertising, pop-up advertising, and mobile advertising.

Social media platforms are Internet platforms that allow users to post content and interact with one another. Users of social media platforms often have the ability to engage in conversations with other users privately or publicly; post pictures, videos, audio, and other media; modify content; and utilize other functionality built into the platform. Users of social media are often able to create virtual connections with “friends,” “followers,” or other groups of users who agree to a connection and interaction with a particular user.

While many social media users may engage in social media use for entertainment, communication, or other non-monetary reasons, some users of social media engage in social media use for marketing, business networking, advertising, sales, or other monetary or promotional reasons. In using social media for these reasons, a user may post, publish, or otherwise include content in the user's social media profile and interactions to facilitate the user's individual monetization goals. This is a type of online advertising specifically targeting social media page viewers. On some social media platforms users may change links in their profile frequently to maximize the monetization of their page by linking to new or different advertisers and/or advertisements.

In some instances, social media sites are actively attempting to restrict the ability of users to advertise on their platform. In some instances this involves restricting the ability of users to change or frequently post links. The social media platform may restrict, remove, revoke, suspend, or otherwise take away the ability to post links. At that point the user may lose some monetization ability.

As such, it is beneficial to create a new platform for users of social media to conduct advertising or other promotional activity to circumvent social media platform restrictions.

### SUMMARY

The embodiments disclosed herein solve the problem of social media restricting the ability of a user to advertise. They allow a user the ability to monetize a social media page on a social media platform even if the platform restricts, removes, revokes, suspends, or otherwise takes away the user's ability to post or frequently change links.

The concept provides a method and system by which a user may post a minimal number of links (preferably only one link) on a social media platform (such as on the user's social media profile) that will direct a viewer to an article including advertisements or standalone advertisements that the user wishes to share. By using a single or limited number of links the user is able to circumvent social media platform monitoring of frequent link changes and therefore maintain monetization of a social media profile.

The methods and systems conceived also provide the ability to monetize social media profiles on social media platforms which do not allow posting of any links In this case, the method and systems provide users with a simple (in some instances one word) URL to post so that a viewer or visitor of the profile can easily type the URL into a browser.

### BRIEF DESCRIPTION OF THE FIGURES

Illustrated in the accompanying drawing(s) is at least one of the best mode embodiments of the present invention In such drawing(s):

FIG. 1A is an example embodiment of a basic network setup.

FIG. 1B is an example embodiment of a network connected server system.

FIG. 1C is an example embodiment of a user device.

FIG. 2 is an example embodiment of a flow chart diagram showing system interaction.

FIG. 3 is an example embodiment of a login screen.

FIG. 4 is an example embodiment of a home screen.

FIG. 5 is an example embodiment of a search screen.

FIG. 6 is an example embodiment of an article decision screen.

FIG. 7 is an example embodiment of an article publishing screen.

FIG. 8 is an example embodiment of an account selection screen.

FIG. 9 is an example embodiment of an account modification screen.

FIG. 10 is an example embodiment of a dashboard interaction process.

FIG. 11 is an example embodiment of an advertisement budget with timing features.

FIG. 12A is an example embodiment of an incoming advertisement offer process.

FIG. 12B is an example embodiment of an outgoing advertisement offer process.

FIG. 13 is an example embodiment of a negotiation process for users and third parties.

### DETAILED DESCRIPTION

Architecture: Mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment and devices as appropriate to implement the methods and systems are contemplated.

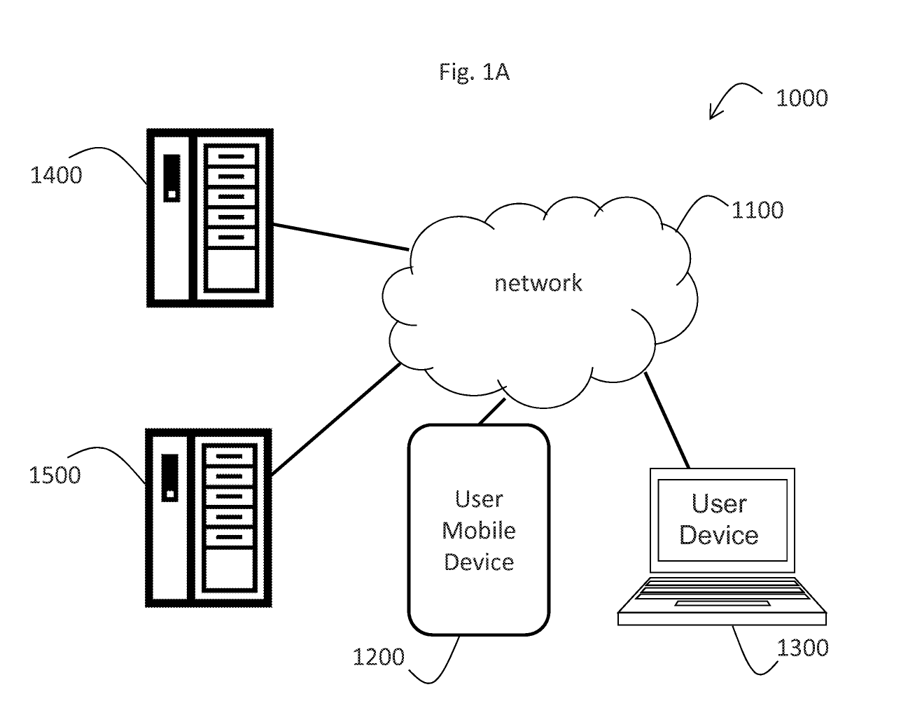

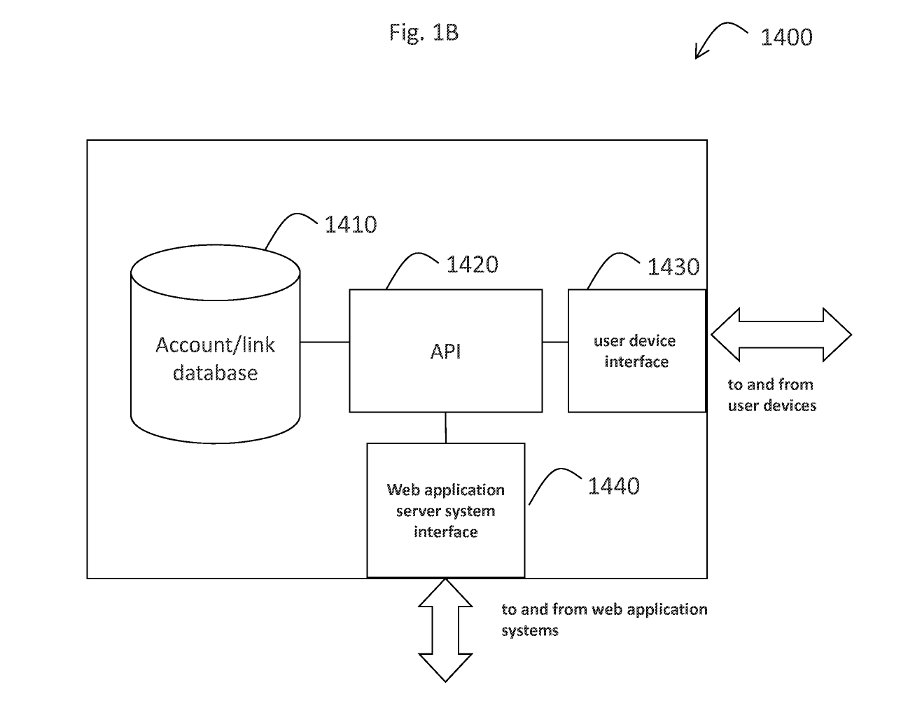

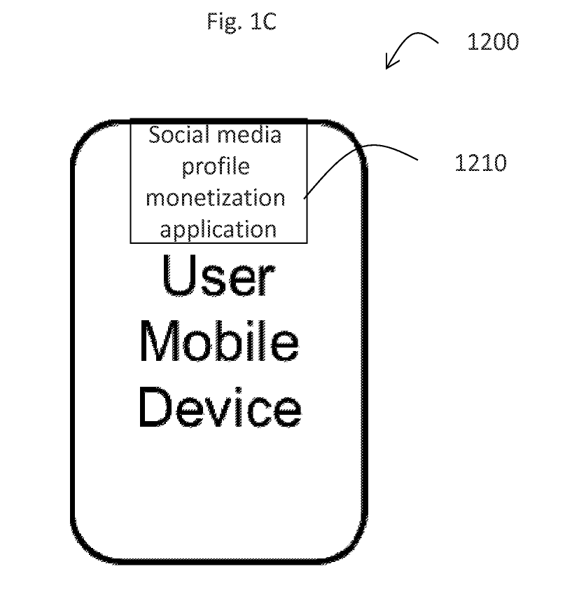

FIG. 1A shows a diagram of a server system 1000 with multiple servers 1400 and 1500 which can include applications distributed on one or more physical servers, each having one or more processors, memory banks, operating systems, input/output interfaces, and network interfaces, all known in the art, and a plurality of end user devices 1200, 1300 coupled to a network 1100 such as a public network (e.g. the Internet and/or a cellular-based wireless network, or other network) or a private network. User devices include for example mobile devices 1200 (e.g. phones, tablets, or others) desktop or laptop devices 1300, wearable devices (e.g. watches, bracelets, glasses, etc.), other devices with computing capability and network interfaces and so on. The server system 1000 includes for example servers operable to interface with websites, webpages, web applications, social media platforms, advertising platforms, and others.

FIG. 1B shows a diagram of a server system 1400 according to an embodiment of the invention including at least one user device interface 1430 implemented with technology known in the art for communication with user devices. The server system can also include at least one web application server system interface 1440 for communication with web applications, websites, webpages, websites, social media platforms, and others. The server system 1400 can further include an application program interface (API) 1420 that is coupled to a database 1410 and can communicate with interfaces such as the user device interface 1430 and web application server system interface 1440, or others. The API 1420 can instruct the database 1410 to store (and retrieve from the database) information such as link or URL information, user account information, associated account information, or others as appropriate. The database 1410 can be implemented with technology known in the art such as relational databases and/or object oriented databases or others.

FIG. 1C shows a diagram of a user mobile device 1200 according to an embodiment of the invention that includes a network connected social media profile monetization application 1210 that is installed in, pushed to, or downloaded to the user mobile device 1200. In many embodiments user mobile devices 1200 are touch screen devices such as smart phones or tablets. User mobile devices 1200 are implemented with memory, processors, communications links, power supplies such as batteries, interfaces such as screens displaying GUI's, buttons, touchpads, software stored in memory and executed by processors, audio input and output components, video input and output components, and others. Software can include computer readable instructions stored on computer readable media such as computer memory.

Setup, User and Viewer Interaction

The description below focuses on a mobile device use case but other uses are contemplated.

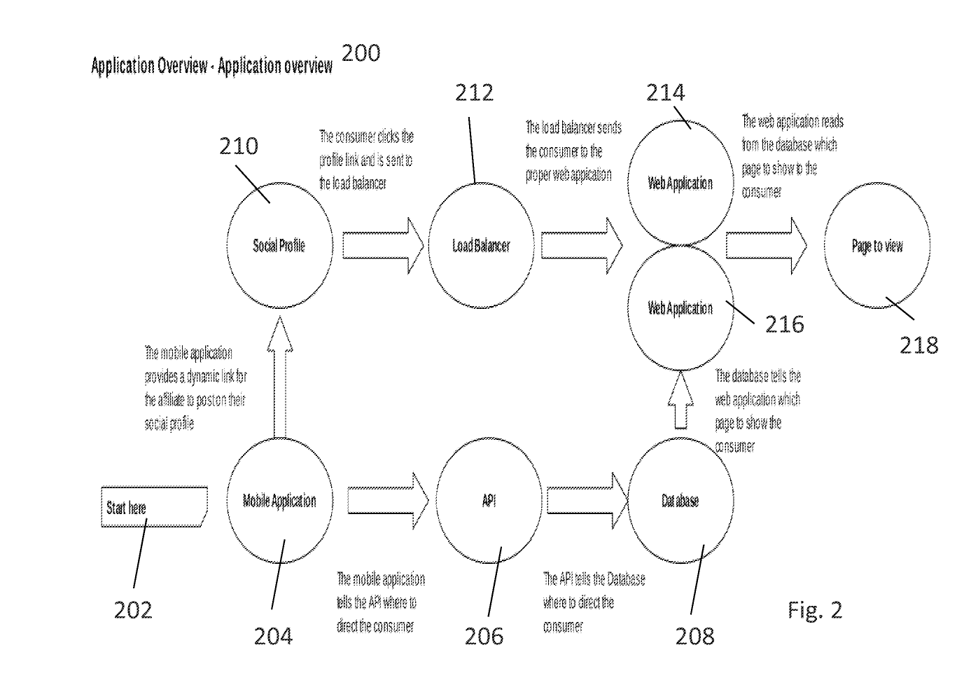

Turning to FIG. 2, an application overview 200 is shown. First, a social media user (“user”) with a social media profile (“profile”) has the opportunity to sign up for the system described herein. For instance, the user can sign on to a system website or download a mobile device application and select a sign-up link in step 202. After or concurrent with signing up, the user may download a mobile application to a mobile device (if not already performed, such as if the user signs up on a system website), install the application, start the application, and log in with step 204.

After signing in, the mobile application can provide the user with a dynamic link or URL to post in the user's social profile or otherwise share on the user's social profile if posting links in social media profiles is unavailable due to restriction by the social media platform in step 210. In some cases the user posts a link to their profile and it shows as a link. In some cases a user may post a URL for viewing by social media profile viewers.

The link or URL (used interchangeably hereafter) is dynamic. Dynamic in this case can mean that although the link or URL may always appear the same on the front end (such as a URL for “www.ilovelittlebordercolliepuppies.com”), the back-end of the link can be changed or adjusted frequently by system administrators or users. That is, although the front-end social media profile viewer can see a single link that remains constant on the social media profile each time the viewer views the social media profile during a day, week, month or other time period—the link or URL may redirect the viewer upon clicking, selecting, or following the link or URL based on back-end design. This can be done through different processes including link redirects.

In many instances, upon setting up an account, the system will query a user as to whether the user desires a particular link or URL. Upon receiving input from the user (for instance that the user wants to use “www.ilovelittlebordercolliepuppies.com”), the system can automatically perform a search to determine if the domain name is taken or reserved. If the domain name is taken or reserved then the user can be informed and asked to enter another desired link or URL. If the domain name is not yet taken or reserved then the user can be informed that the URL is open and asked whether the user would like to purchase the domain name. Users can purchase the domain name through the system in some instances. In other instances a system administrator can purchase the domain name manually for the user or the system can automatically purchase the domain name for the user.

After assigning the link or URL to a particular user, the mobile application can send a message via the API to the back end in step 206 that updates information about what location to direct viewers who follow the link or URL that the user is posting in the user's social media profile. The mobile application can send these messages via the API frequently, thus leading to the dynamism of the link. After receiving an API call or instruction, a database can associate the link and the location and store the information as a current redirect instruction. This current redirect instruction can be sent to a web application which can be accessed by a social media profile viewer who selects the link or URL for viewing.

After downloading a link or URL the user can share it on the user's social media profile by making it public, such as by publishing it. In many instances the user can include the link in a portion of the social media profile containing self-descriptive biographical information. Many viewers may see the link or URL just by reading this biographical information portion of the user's social media profile. In some instances the user may desire to entice additional viewers to view the published link or URL.

The link or URL is not limited to pointing solely to websites. In some instances interacting with the link or following the URL can be used in direct download campaigns. As an example, a user may publish a message stating “I am having so much fun playing [Game Title], go to the link in my profile to download the app” where [Game Title] may be a current popular game such as Flappy Bird by .GEARS Studios. Upon selecting the link in the profile, the viewer may be taken from the profile to the web server and then directed to an online marketplace such as an application store.

The user may entice additional viewers to view the published link or URL in many different ways including by publishing information in locations where “friends”, “followers”, contacts or other viewers may see the information. This publishing of information may exist in different forms on different social media platforms. On some platforms publishing information can occur by publishing information on the user's own publicly viewable, editable, interactive page (sometimes referred to as a “wall”). On some platforms this publishing can be reproduced in a “news feed” or other location where viewers may view recent updates by “friends”, “followers”, or contacts. On some platforms this publishing can occur on other user profiles, in public forums, in group forums, in private forums, in personal messages to one other user, in group messages, in mass messages, in comment sections on third party websites, in review sections on third party websites, in rating postings on third party websites, in emails, text messages, instant messages, multimedia messages, video messages, video uploads, in vlog postings, in blog postings, in microblog postings, in wiki postings, in podcasts, or others. Some examples of social media platforms include Facebook by Facebook, Inc., Twitter by Twitter, Inc., Vine by Vine Labs, Inc., Instagram by Instagram, Inc., Snapchat by Snapchat, Inc., and others.

As described above, in some instances users can include instructions to view links in video content uploads. As an example, a user can upload a video on a social media platform. The video can include an actor in the video holding a sign at the end of the video that says “To see how this ends click on the link in my profile”. Alternatively, the video may include an actor in the video holding a sign at the end of the video that says “To see how this ends go to ilovelittlebordercolliepuppies.com”.

As another example, a user can instruct viewers to click the link in the user's profile. In an example instance this occurs when the user publishes (sometimes referred to as “posting”) a picture on a publicly viewable interactive page (“wall”). In one example, a user may publish a picture of a comedian. The picture of the comedian can also include associated text that states: “Click the link in my bio for the funniest comedians of Summer 2014.” This may entice a viewer to view the user's personal information located in the user's biographical information section of the user's social media profile and click on the link that is located there.

After clicking on a link or following a URL a viewer may be sent to a load balancer in step 212 which in turn directs the user to a web application in step 214. This web application may then access the same database that received the API call in step 216 that instructed the database about what location to direct viewers who follow the link or URL after the user chose the link or URL at an earlier step. After receiving the location to direct viewers information from the database the web application may direct viewers to the correct web page in step 218. The database is typically located on a system server.

Use of the System By Users

After the initial setup described above, users have numerous opportunities to interact with the system and customize content to publish on social media platforms.

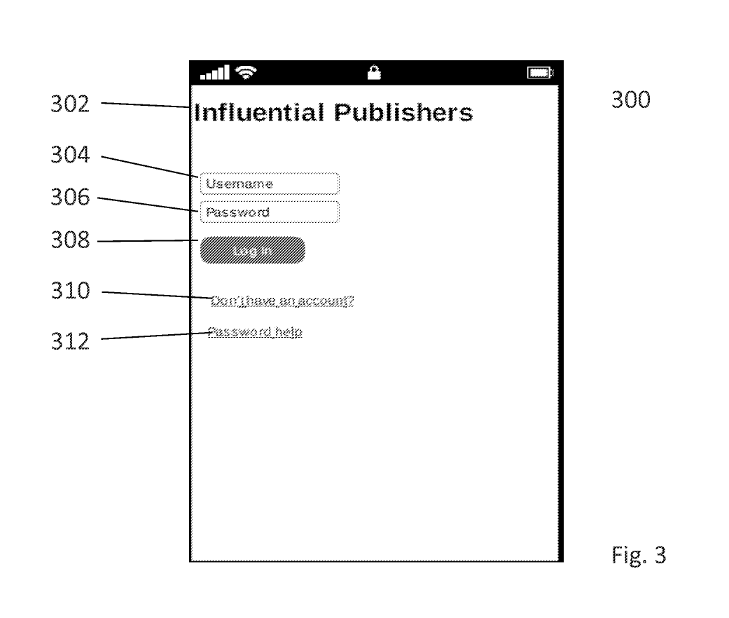

When opening an application, a user is generally presented with a login screen 300, as shown in FIG. 3. Login screen 300 includes a header 302 which can be an application title, a username field 304, a password field 306, a login button 308, an account signup button 310, a password help button 312 and others.

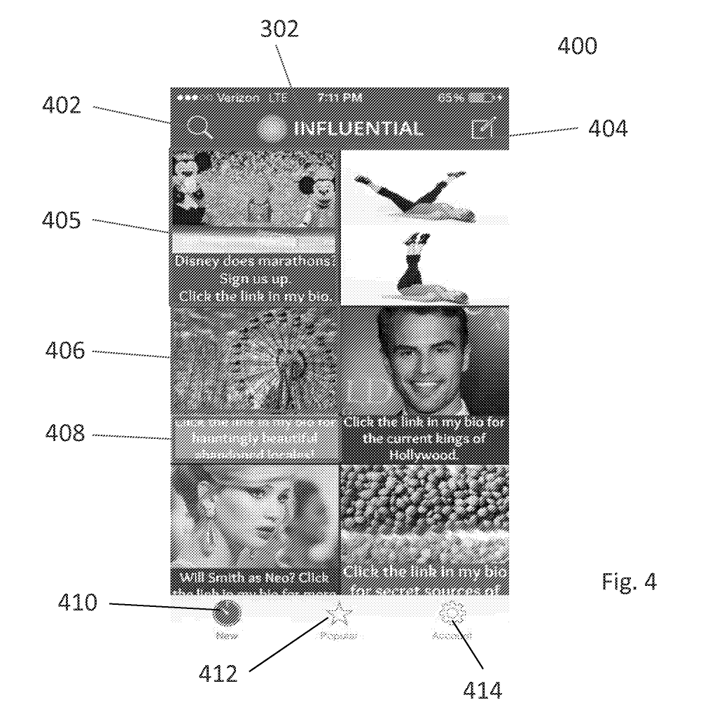

Upon effectively logging in using a login screen 300 as shown in FIG. 3, users are presented with a homepage screen 400 as shown in FIG. 4. Homepage screen 400 provides users with numerous articles 405 which the user may wish to publish on social media. Articles 405 can include an image 406 and a description 408. FIG. 4 shows six articles 405 for example with pictures 406 and associated text description 408 with the ability to scroll down, up sideways or otherwise for additional articles. The user can also search for particular articles by selecting the spyglass icon 402 in the top left corner or create unique articles by selecting the pencil and paper icon 404 in the top right corner. Lists of articles are grouped as “new” 410 and “popular” 412 at the bottom of the screen. Also included is a button which allows users to interact with personal account settings 414 including adding social media profiles.

In some instances users may wish to create their own articles by selecting the pencil and paper icon 404. After selecting this icon the user can be brought to a new screen with preset fields the user may use including a title, description, front page illustration, or others. Upon creation of an article, the article can be directly uploaded to the server. In some instances the user can grant the mobile application access to memory on the mobile device in order to upload pictures, video, text, audio, or other saved content for use in an article. In some cases uploading an article can require a moderator's approval before being publicly posted.

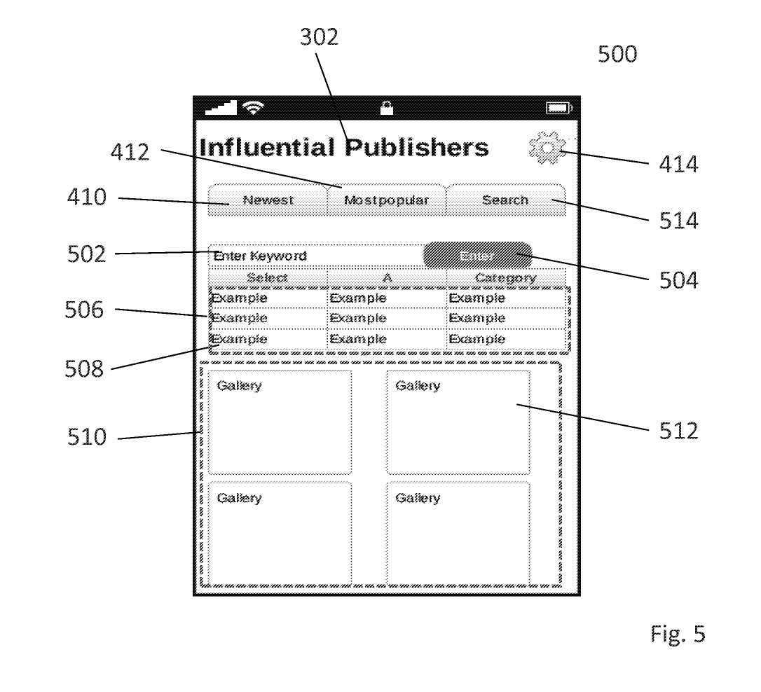

FIG. 5 shows an example of a user interface screen 500 which a user can interact with after selecting the search functionality icon 402 (previously referred to as the spyglass icon). From this screen a user can input a search topic using keywords or other searching functions such as dates, article creators, or others criteria in an input field 502. After confirming the search topic by selecting the “enter” button 504 the user can be presented with articles which match or are otherwise associated with the search topic. From there a user may select an article for publishing by selecting the article and publishing.

In some instances articles are organized in searchable categories 508 (in some instances in menus) in a category selection field 506 with a particular theme such as “health and fitness”, “animals”, “science and technology” and others. Sub-categories may also exist in hierarchical form within the category menu such as “animals” with subcategories “farm animals”, “wild animals”, “pets” and further into sub-subcategories such as “pets” being further broken into “cats”, “dogs”, “aquarium fish”, “reptiles” or others.

Additionally, for users who want to quickly publish or do not particularly care about searching for a particular article, a gallery selection field 510 can include a number of galleries 512 which are randomly or otherwise assorted by system administrators or algorithms. In an example embodiment the most recent article can be shown first followed by the second most recent article and so on.

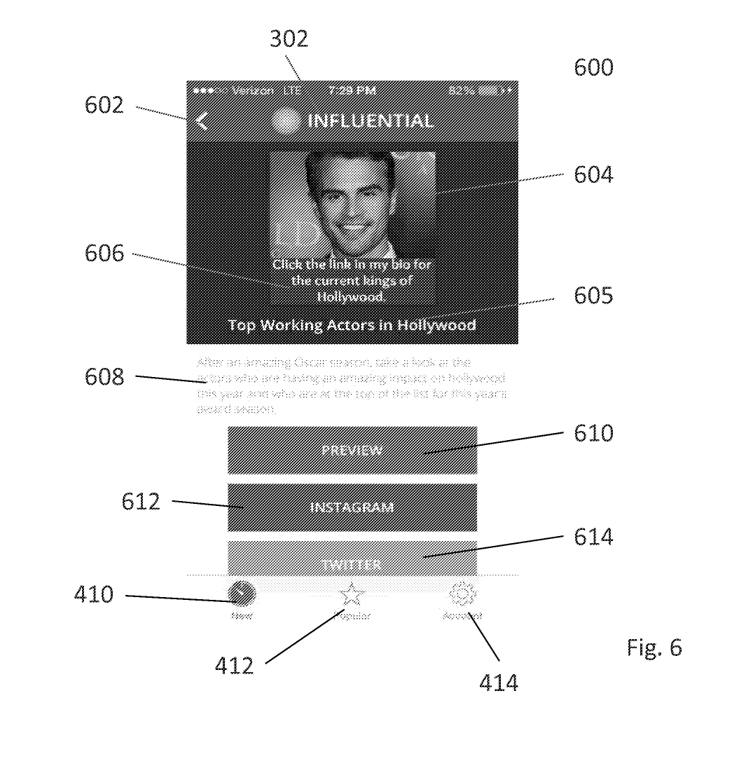

Once an article is selected by a user for publishing, the user can be shown an article decision screen 600, as shown in the example in FIG. 6. The article decision screen 600 shown in FIG. 6 allows the user to perform numerous actions. The article decision screen shows the article to be published if the user chooses to publish on social media in the middle of the screen including an associated title 605, picture 604 with reference to the profile link 606, and brief description of the article 608. Also included is a “preview” button 610 which allows the user to view the article as a viewer might if the viewer chooses to follow the link in the user's social media profile. If the user does not wish to view a preview of the article before publishing it to a social media platform the user can simply select the button 612, 614 with the social media platform title such as Twitter by Twitter, Inc., Instagram by Instagram, Inc., and others. A back button 602 is also provided if the user wishes to return to the previous screen.

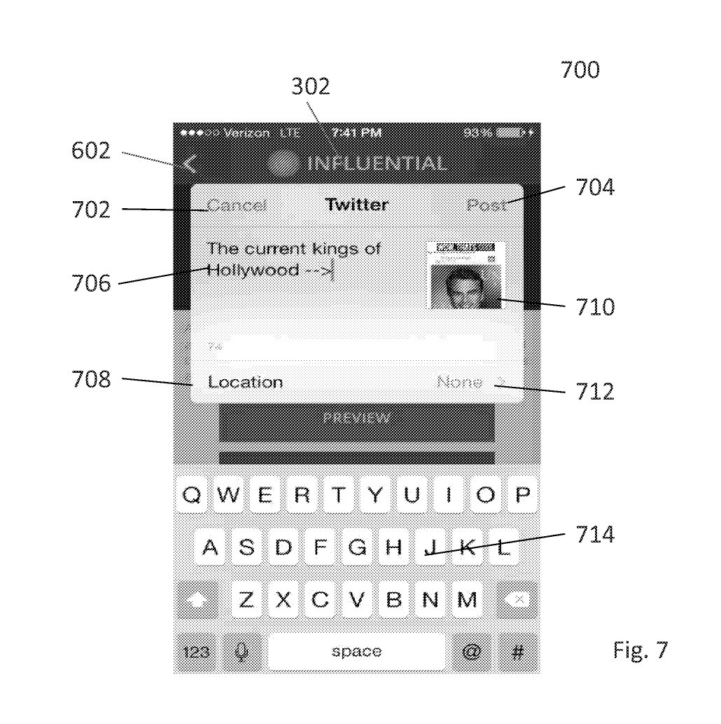

FIG. 7 shows an example of an article publishing screen 700 in the case where a user has chosen to publish to social media platform Twitter. A proposed blurb 706, editable by the user using keypad 714, is shown along with a preview of the associated article 710. The user can edit blurb 706 before publishing to the social media platform by selecting a post button 704 and can also choose to include other information. In the example shown in FIG. 7 the user has the option of including location information 708 (such as map coordinates or other location approximating information 712). Other additional information can also be included in other instances. A user can also cancel an article if they change their mind about publishing it by selecting a cancel button 702.

Once an article is published to a social media account on a social media platform by a user, a viewer may be enticed to select a link or follow a URL in the user's social media profile. Upon selecting or following the link or URL, the viewer is taken to the associated webpage including the most recent article posted by the user. The viewer can then view the article, including associated advertising located on the webpage or otherwise associated with it (such as popup advertising). Upon completion of the article, the viewer can be presented with options such as view related articles, view new articles, view article categories, or others. If the viewer chooses to continue viewing articles then the system can track articles the viewer selects and adaptively predict additional articles which may be of interest to the viewer. The system can also track advertisements the viewer selects in order to compensate the user for creating or posting articles which are successful in enticing viewers to view and select advertising. These can include a total number of visitors, a total number of unique visitors, a number of page views, an average number of pages viewed per visit, and others.

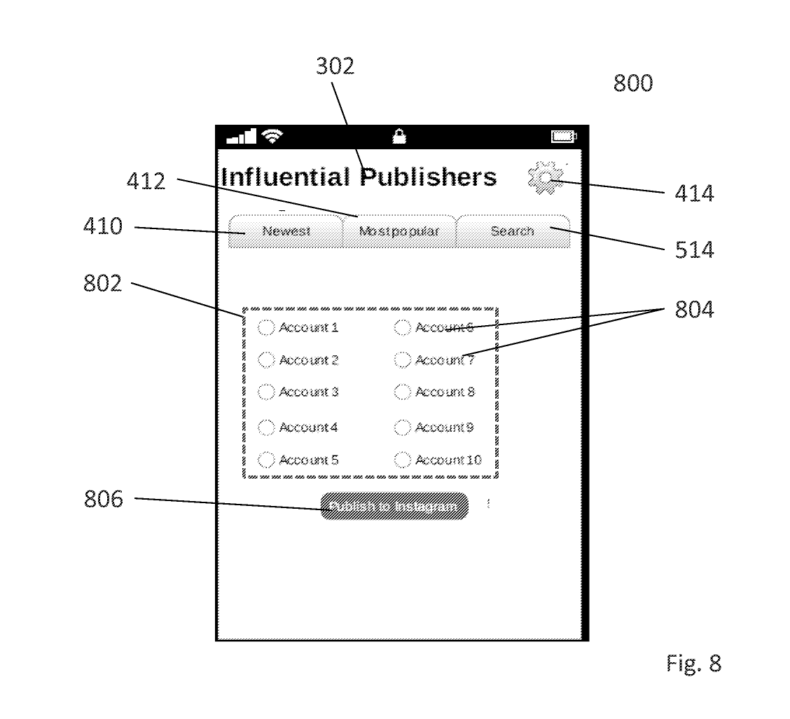

FIG. 8 shows an account selection screen 800. Account selection screen provides the user the ability to easily select at least one from amongst numerous linked social media accounts 804 in an account selection field 802, even when the user has multiple social media accounts on a single social media platform. In the example shown radio buttons are provided for user interaction but in other instances other selection abilities or functionality may be used such as allowing multiple accounts to be chosen at the same time.

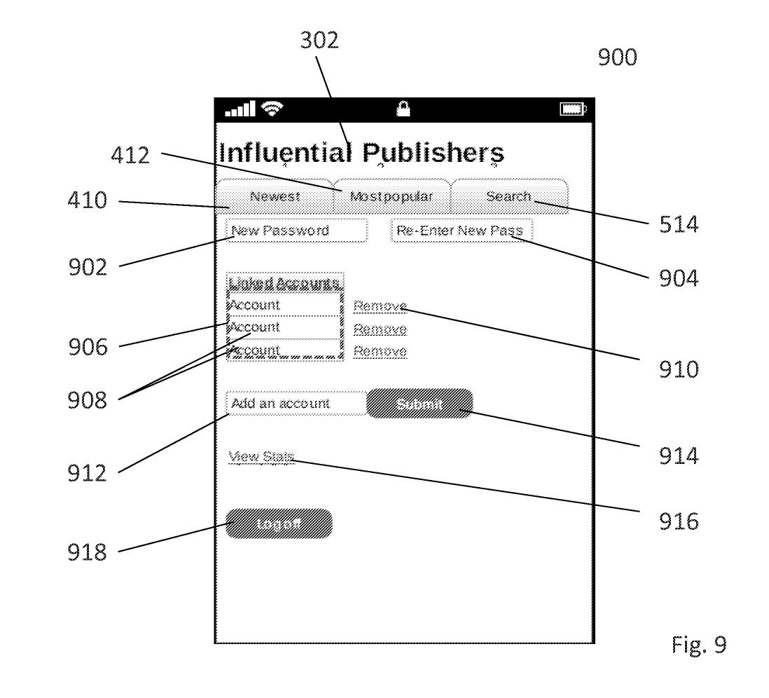

FIG. 9 shows an account modification screen 900. From the account modification screen 900 users have the ability to view which social media accounts 908 are currently linked to the system including information about the associated social media platforms in a linked accounts field 906. Also included are removal buttons 910 which, when selected, remove or uncouple associated currently linked accounts from the system. An account adding field 912 allows a user to type in a new account to add by submitting with submit button 914. A view stats button 916 allows a user to view statistics about each account. Statistics can include how many viewers have followed the user's recently posted links in the previous hour, day, or week. Statistics can also include how much money has been paid to each account the user has associated with the system, which accounts the user has are most popular, how often a user uses each linked account, upcoming advertising campaigns, and many others. System passwords can also be changed from this screen using a new password entry field 902 and confirmation field 904. Users can also log off the system using a log off button 918. In many embodiments this shuts the system down but associated profiles are still stored in the system and associated.

Additional Information

Programmatic marketing can be used in some instances by the system. Additionally or alternatively, direct offering or direct buy may be used as well.

In many instances articles have embedded advertising in the form of pop-up windows, banner advertising, or other past, present, or future Internet advertising techniques. Many of these advertising techniques can be used in conjunction with the system in order to monetize social media profiles.

In some instances the system may recommend to a user a particular article and an associated time/date to post the article. This feature provides users with time-sensitive monetization ability. As an example, if a new movie is being released on Thursday, May 15 a movie studio may wish to engage in advertising on social media using the system described herein. The movie studio may use the system to drive traffic to a particular webpage with advertising using profile links provided by users. Once the system receives advertising information about the movie release from the movie studio, such as the URL of a website with associated material, it may send a time/date request to a user to post the gallery and use link redirection to drive traffic to the website for the movie studio. As such, users may be compensated monetarily for driving traffic to the website.

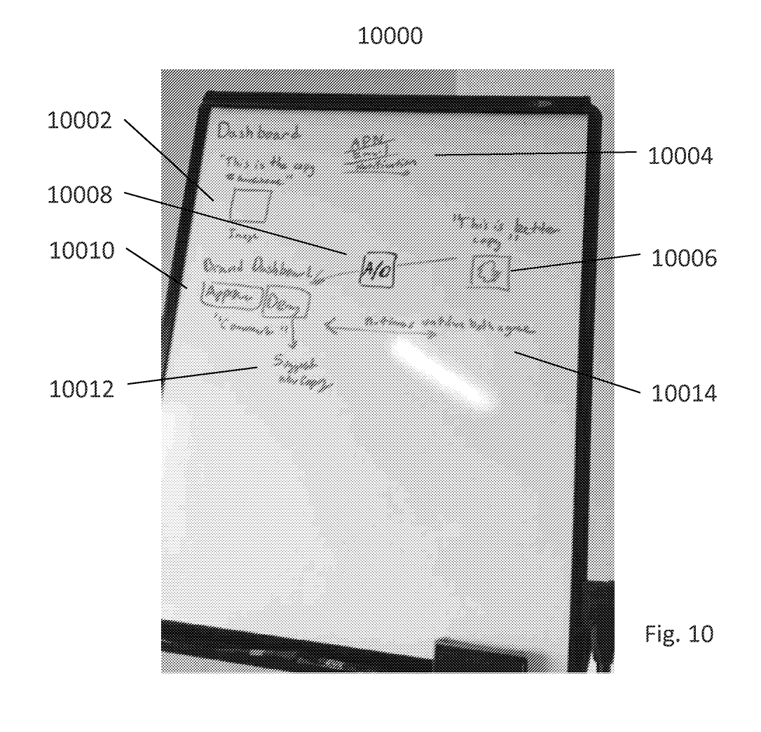

FIG. 10 is an example embodiment of a dashboard interaction process 10000. In the example embodiment the dashboard can be a primary location for negotiations between system users and system administrators or third parties such as advertisers. In the example embodiment a user can view a particular advertisement for posting from an advertiser on the user's dashboard in step 10002. Here the advertisement says “This is the copy #awesome” and includes an image. A notification can be sent in the form of a push notification, email, text message, or other notification to the user in step 10004 that the advertisement is available for the user to begin posting and can include a particular timing in the future or it can be ready to post instantly. The user can choose to post the advertisement as it is or can propose a new copy for review in step 10006. Here the user has proposed “This is better copy” with a new image. One or a combination of a system administrator and automated process can filter the proposal in step 10008 by checking for inappropriate language, inappropriate image content or other prohibited actions before forwarding to the advertiser for review. This can be accomplished by using an API call to the system can check for flagged words and determination that the post should be flagged. Once forwarded to the advertiser for display and review on an advertiser dashboard, the advertiser can approve or deny the proposal in step 10010. If the advertiser denies the proposal the advertiser can suggest a new advertisement in step 10012 and the process can begin again from step 10002. If the advertiser agrees or approves of the advertisement suggested by the user then a deal has been reached.

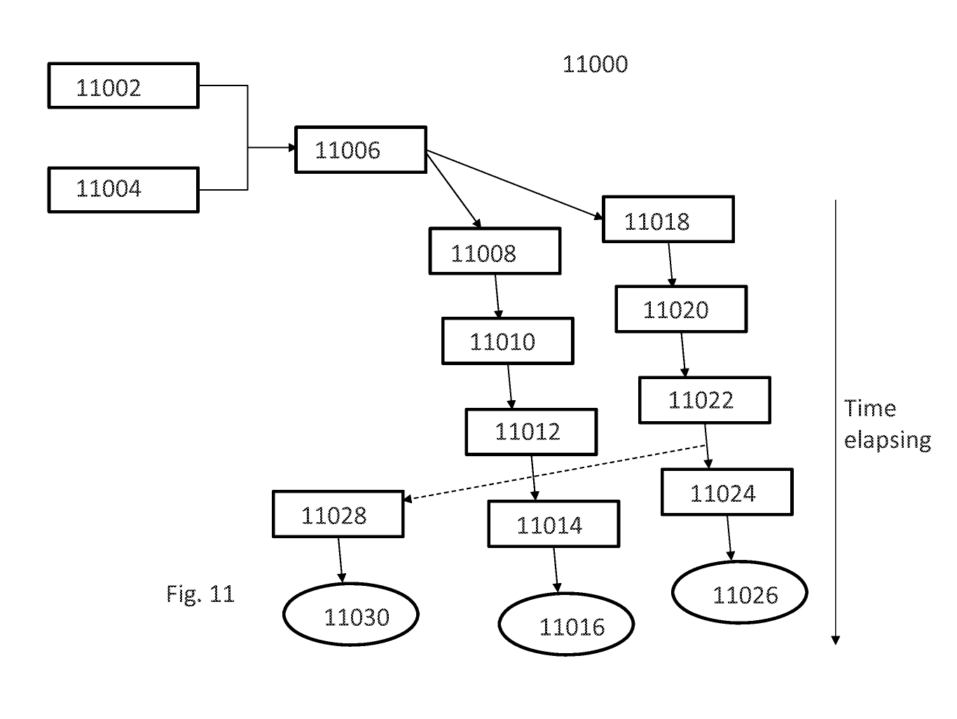

FIG. 11 is an example embodiment of an advertisement budget with timing features. In the example embodiment an advertising budgeting deal can be set in step 11002 and an advertisement can be set in step 11004. In this example, the budget can be $1000 for a promotion on Feb. 24, 2015 and the advertisement can read “This soda is great.” The system can then send a push notification in step 11006 to selected primary advertisers. Advertisers can have equal weight or be weighed differently depending on their outreach (number of friends/followers/etc.), notoriety in a particular field (fashion/science/medicine/etc.), likelihood of responding based on prior interactions with the system, or other factors. In the example embodiment an offer to a first user can be $700 initially in step 11008 while an offer to a second user can be $300 initially in step 11018. As shown in the example embodiment, a decaying value of the offer can then occur based on a preset timing element. This can encourage quick response from system users to be actively engaged with the system. In some embodiments a quick response can be accomplished by sending a response message to the system in the form of selecting a particular button onscreen, sending a message, sending an email or other acknowledgement indicator. A minimal reward can be given in some embodiments such as $1 for selecting a denial of offer indicator in order to further promote engagement with the system even though a user chooses not to engage in a particular promotion or advertising campaign. After an initial timing threshold has been reached, a first decay occurs to step 11010 and 11020 for first and second users respectively, in the case where neither has accepted the advertising campaign. As such values for each can decrease from $700 to $600 and $300 to $250 respectively, or whatever other values the system uses based on metrics or programmed encouragement analytics. In a case where each user does not accept by a subsequent time threshold, a subsequent decay can occur in steps 11012 and 11022. At a threshold time if one or multiple users have not accepted an advertising campaign then a backup user or users can be added, indicated by step 11028 with a new value, such as $100. An expiration can occur individually for each user in steps 11016, 11026, and 11030 or simultaneously.

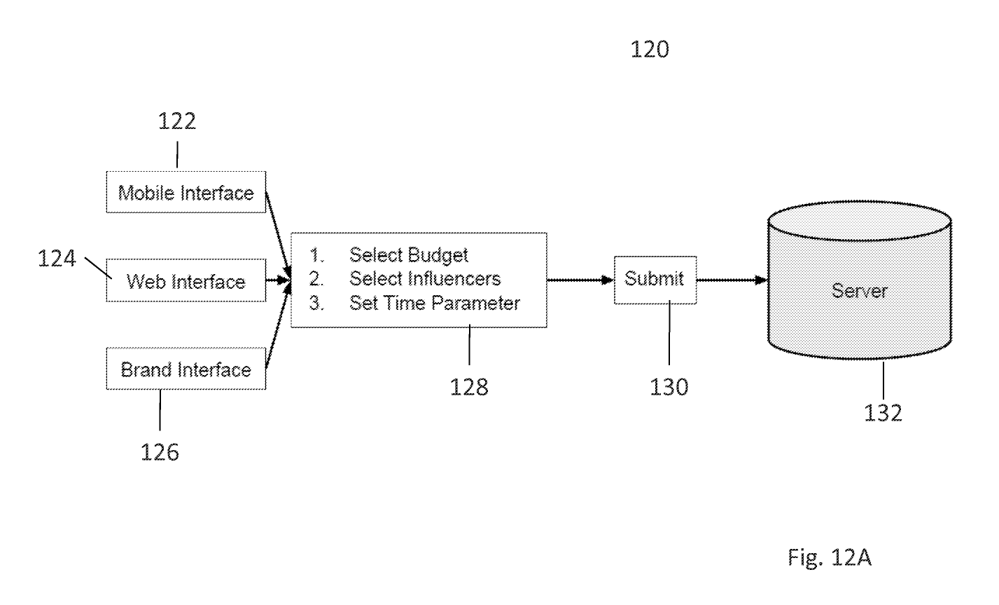

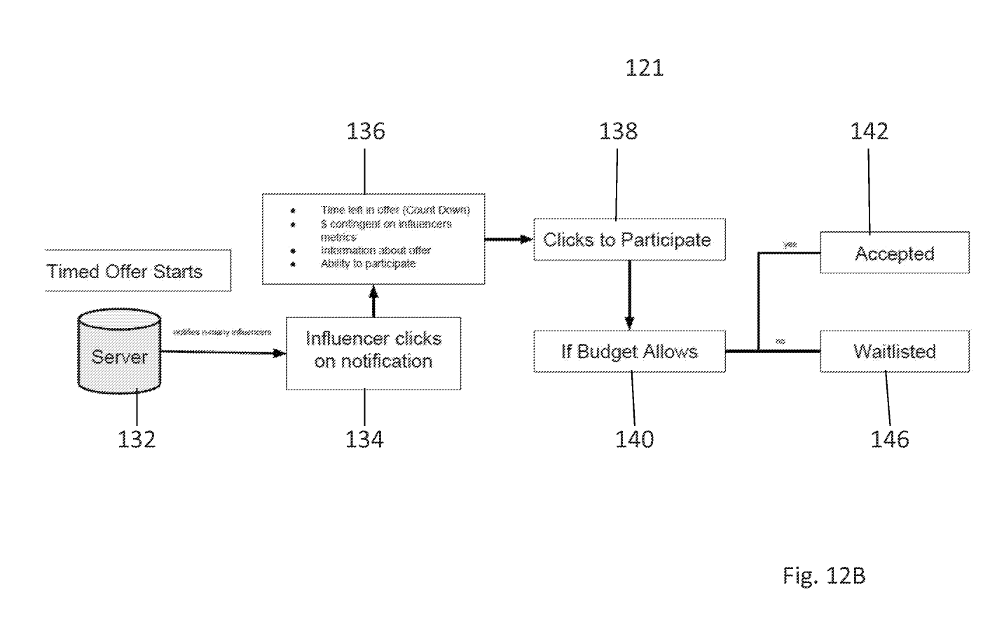

FIG. 12A is an example embodiment of an incoming advertisement offer process 120. In the example embodiment one or multiple of a mobile interface 122, web interface 124 and brand interface 126 can be used to create an advertising campaign in step 128 by selecting a budget, selecting users (also called “influencers”) to carry out the campaign and a time parameter for a length of the campaign. Once these choices have been selected they can be submitted in step 130 and stored in a database on server 132.

FIG. 12B is an example embodiment of an outgoing advertisement offer process 121. In the example embodiment a timed offer can start and a server 132 can notify selected users by sending push notifications or using other notification schemes. Then in step 134 a user can select the notification to view and in step 136 can be shown the time left for the particular campaign, the monetary amount contingent on the user's metrics as described previously, information about the campaign or offer and an option to participate or pass on the campaign. If the user wishes to participate they can select an appropriate option in step 138 such as clicking a participation icon. The system can check whether a budget allows the user to participate in step 140. This step ensures that if offers to join the campaign are sent to more users than the budget allows, that the campaign will not overrun its budget. As such, if the budget allows then a user can be accepted in step 142 and if the budget does not allow then the user can be added to a waitlist or queue in step 146.

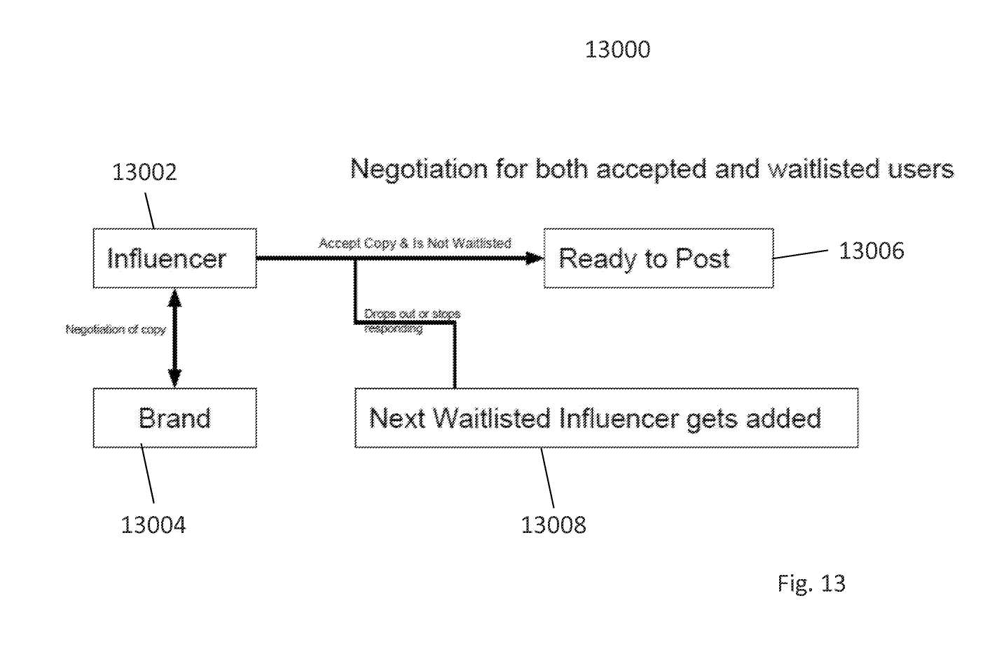

FIG. 13 is an example embodiment of a negotiation process 13000 for users 13002 and advertiser 13004. In the example embodiment a user 13002 and advertiser 13004 can negotiate aspects of an advertising campaign including images, timing, text, price, and others. If the user 13002 and advertiser 13004 agree to terms then the system can determine whether the user is on a waitlist or not. If the user 13002 is not on a waitlist the system can clear the user to post or to schedule a post in step 13006. If a user 13002 drops out of an advertising campaign or stops responding to messages in a timely manner, as measured using timing thresholds or a countdown timer, a next waitlisted user can be added to a primary list of users in step 13008 who are active for the current campaign.

What is claimed is:

1. A computer-based system for monetizing social media profiles on social media platforms, comprising:
providing a link or URL for a user publish to a social media profile on a social media platform, where the link or URL is controlled by the system;
providing at least one article for the user to publish to the social media platform instructing viewers to select or follow the link or URL; and
directing or redirecting a viewer who selects or follows the link or URL to a webpage containing advertising.

2. The computer-based system for monetizing social media profiles on social media platforms of claim 1, further comprising:
an advertiser-user campaign management system, wherein an advertiser selects a budget, selects at least one user to implement an advertising campaign, and sets a time parameter, each of which are stored to a database on at least one server.

3. The computer-based system for monetizing social media profiles on social media platforms of claim 2, wherein the server sends a campaign initiation notification to the at least one user, the campaign initiation notification including information about an offer to engage in the campaign including a payment offer for participating and a time limit for expiration of the offer.

4. The computer-based system for monetizing social media profiles on social media platforms of claim 3, wherein if the user selects an offer to participate, the server system determines whether the budget allows for the at least one user to participate and accepts the user as a participant if the budget is not exhausted or waitlists the user if the budget is exhausted.

5. The computer-based system for monetizing social media profiles on social media platforms of claim 2, further comprising:
a negotiation platform, wherein the at least one user negotiates participation aspects including a payment value, an advertisement language and an advertisement image using a counteroffer.

6. The computer-based system for monetizing social media profiles on social media platforms of claim 5, wherein a system review process allows the system to review the participation aspects of the counteroffer before forwarding the counteroffer to the advertiser.

7. The computer-based system for monetizing social media profiles on social media platforms of claim 1, further comprising:
an account management system, operable to allow a user to couple multiple social media accounts on at least one social media platform to the system for advertising purposes.

8. The computer-based system for monetizing social media profiles on social media platforms of claim 1, further comprising:
an advertisement selection system, wherein a user can search for advertisements to post to social media profiles by targeting a category and browsing advertisements within a category.

9. A computer-based system for monetizing social media profiles on social media platforms, comprising:
software stored in memory and executed by processors causing:
an advertising campaign offer to be displayed to a first user on a first user device with an option to accept or negotiate the advertising campaign offer;
if a user negotiates the advertising campaign offer, sending a counteroffer to an advertising campaign originator where the system determines whether the counteroffer is appropriate by comparing with language stored in a database; and
displaying the counteroffer on a campaign originator device with an option to accept, deny or further counteroffer.

10. The computer-based system for monetizing social media profiles on social media platforms of claim 9, further comprising:
a campaign control module operable to allow the originator to select a budget, select users to advertise and select a time parameter during which the users have to accept before the offer expires.

11. The computer-based system for monetizing social media profiles on social media platforms of claim 10, wherein the time parameter affects a monetary value of the offer for each user over time.
